(19) United States
(12) Patent Application Publication
(10) Pub. No.: US 2009/0200013 A1
(43) Pub. Date: Aug. 13, 2009

(54) WELL TUBULAR, COATING SYSTEM AND METHOD FOR OILFIELD APPLICATIONS

(76) Inventors: Bernadette Craster, Edmonton (CA); Ahmed Hammami, Edmonton (CA); Tim G.J. Jones, Cambridge (GB); Todd Yakimoski, Beaumont (CA); Jiarong Wang, Edmonton (CA); Stephen M. Dershem, San Diego, CA (US)

Correspondence Address: SCHLUMBERGER CANADA LIMITED, 9450 17TH AVE, EDMONTON, AB, T6N 1M9, CA

(21) Appl. No.: 12/428,711

(22) Filed: Apr. 23, 2009

(51) Int. Cl. E21B 17/00; F16L 58/04; B05D 5/00; B05D 3/02; E21B 41/02

(52) U.S. Cl. 166/242.4; 427/399; 427/400; 427/372.2; 507/229

(57) ABSTRACT

A technique facilitates the use of polymer materials in a downhole environment via utilization of a coating that can be applied to the polymer material. The methodology enables formation of a coating that sufficiently bonds with an underlying base structure of polymer material to withstand the harsh environment encountered in a downhole application. Additionally, the coating may utilize reactive chemistries to further protect the polymer material against the ingress of deleterious fluids while located in the downhole environment. Well tubulars formed of coated polymer are also described.

### BACKGROUND OF THE INVENTION

Oilfield applications often present challenging operational requirements with respect to equipment used downhole. Requirements of oilfield equipment may include high strength, resistance against chemical attack by harsh well fluids, maintenance of mechanical properties at high temperatures, transparency to nuclear, magnetic, acoustic, and inductive energy, and other requirements. Attempts have been made to use polymer tubular products, which may be fiber reinforced, in oilfield applications, but the challenging operational requirements can limit the effectiveness of these components.

For example, polymer materials can deteriorate when exposed to deleterious well fluids such as water, or other fluids containing compounds that alter the mechanical properties of the polymer materials. Additionally, the high temperatures and other harsh conditions of a wellbore environment can limit the long-term functionality of polymer components in a downhole environment.

### BRIEF SUMMARY OF THE INVENTION

In general, the present invention provides a well tubular and a system and methodology for utilizing a coating that can be applied to polymer materials, for use in a high temperature downhole environment. The methodology enables formation of a coating that sufficiently bonds with an underlying base structure of polymer material to withstand the harsh environment encountered in a downhole application. Additionally, the coating may utilize reactive chemistries to further protect the polymer material against the ingress of deleterious fluids while located in the downhole environment.

### BRIEF DESCRIPTION OF THE DRAWINGS

Certain embodiments of the invention will hereafter be described with reference to the accompanying drawings, wherein like reference numerals denote like elements, and:

FIG. 1 is a view of a well system with a coated, polymer component located in a well environment, according to an embodiment of the present invention;

FIG. 2 is an enlarged, cross-sectional view of a portion of the coated, polymer component illustrated in FIG. 1, according to an embodiment of the present invention;

FIG. 3 is a schematic illustration of one example of a coating system that can be used to protect a downhole component formed of polymer material, according to an embodiment of the present invention;

FIG. 4 is a schematic illustration of another example of a coating system that can be used to protect a downhole component formed of polymer material, according to an embodiment of the present invention;

FIG. 5 is a schematic illustration of another example of a coating system that can be used to protect a downhole component formed of polymer material, according to an embodiment of the present invention;

FIG. 6 is a schematic illustration of another example of a coating system that can be used to protect a downhole component formed of polymer material, according to an embodiment of the present invention;

FIG. 7 is a schematic illustration of a multi-reagent particle that can be incorporated into the coating material, according to an embodiment of the present invention;

FIG. 8 is a schematic illustration of another example of a coating system that can be used to protect a downhole component formed of polymer material, according to an embodiment of the present invention;

FIG. 9 is a representation of a chemical reaction that can be used in providing an effective coating material, according to an embodiment of the present invention; and

FIG. 10 is a representation of another chemical reaction that can also be used in providing an effective coating material, according to an embodiment of the present invention.

### DETAILED DESCRIPTION OF THE INVENTION

In the following description, numerous details are set forth to provide an understanding of the present invention. However, it will be understood by those of ordinary skill in the art that the present invention may be practiced without these details and that numerous variations or modifications from the described embodiments may be possible.

The present invention relates to a system and methodology for protecting polymer materials in harsh, downhole well environments. For example, fiber reinforced polymer materials can be used to construct well tubulars or other well components for use in a downhole environment. Well tubulars include, but are not limited to, well casing, production tubing, flow lines, core holders, bridge plugs, liners, and tool housings, such as for logging tools. In some applications, the fiber reinforced polymer material is used to construct casings/liners that are transparent to nuclear, magnetic, acoustic, and inductive energy which allows such tubulars to be used in a variety of logging operations.

Protection is provided in the form of a protective material that may be applied as a coating on the well tubular or well component. When using polymers, the protective coating is used to prevent harsh well fluids, e.g. water, brine, oil-water mixtures, high pH fluids, carbon dioxide, and hydrogen sulfide, from permeating into the material matrix. In many applications, the coating comprises an electrically non-conductive, hydrophobic (i.e. having a water take up of less than 1 weight percent) barrier material. Additionally, the coating may comprise a plurality of layers or segments that may be intermixed or coexistent in the form of modulated, i.e. functionally graded, layers.

In many downhole environments and applications, fiber reinforced polymer composites are beneficial. However, water and other deleterious fluids can be present in the downhole environment naturally or as a result of drilling fluids and cement used during well preparation. The deleterious fluids can diffuse into the fiber reinforced polymer composites and lead to detrimental plasticization of the resin matrix which, in turn, alters the mechanical properties of the downhole component.

According to the present system and methodology, various embodiments of modulated coating layers are used to effectively protect polymer structures in harsh downhole environments. The coating layers may comprise embedded reactive chemistries that offer added protection against specific deleterious fluids. By way of specific example, the fiber reinforced polymer composite component, e.g. tubing, can be formed from bismaleimide, and the coating may comprise material formed from a maleimide complex which chemically bonds to the bismaleimide. The bonded coating protects the downhole component from the ingress of harsh reservoir fluids, e.g. water, brine, oil-water mixtures, high pH fluids, carbon dioxide, and hydrogen sulfide, which, in turn, prevents degradation of the downhole component.

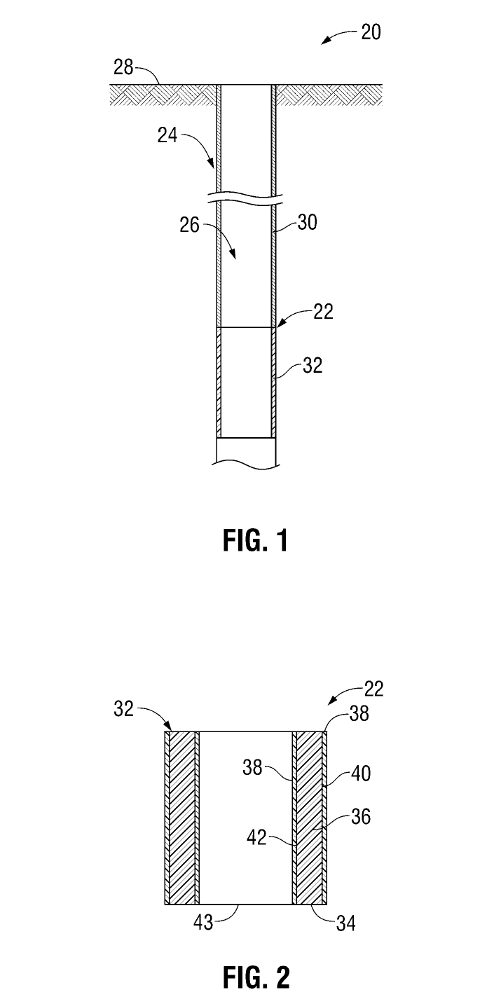

Referring generally to FIG. 1, a well system 20 is illustrated in which a well component 22 is deployed downhole in a well 24 defined by a wellbore 26. The wellbore 26 extends downwardly from a surface location 28 and may be cased with a standard casing 30. The well component 22 may comprise a variety of completion components and other components utilized in many types of well applications. By way of example, well component 22 may comprise a tubular component 32, such as a casing/liner or other wellbore tubular. In this particular example, well component 22 comprises a base structure formed from a fiber reinforced composite, e.g. a fiber reinforced polymer, which is at least partially covered by a protective coating. One method of forming the fiber reinforced composite material into tubular component 32 is to impregnate the fiber material with a thermoset resin followed by winding the resin impregnated fiber over a mandrel designed to create the tubular component in a desired diameter and length. The coating may be applied to desired surfaces of the well component to protect the fiber reinforced composite material while the well component is used in a downhole environment.

In FIG. 2, one embodiment of well component 22 is illustrated and comprises a base structure 34 formed of a fiber reinforced composite material 36. The fiber reinforced composite material 36 is protected by a coating 38. Depending on the configuration of well component 22, coating 38 can be applied to a variety of surfaces. For example, the well component 22 of FIG. 2 is generally illustrated as tubular component 32, and coating 38 may be applied to an external surface 40, and/or an internal surface 42, and/or a bottom edge 43.

The fiber reinforced composite material may comprise a variety of materials. For example, the supporting fiber may be formed from materials including carbon, fiberglass, basalt, quartz, aramid fiber, or other fiber materials. Additionally, the supporting fiber may be combined with a suitable resin, such as a thermoset resin selected from several resin systems, including polyimides, cyanate esters, benzoxazines epoxies, phenolics, polyurethanes, and polyamides. By way of specific example, the thermoset resin may be selected from available bismaleimides (BMI) or various modified/toughened BMI resins. Examples of commercially available thermoset resins that can be used to create the well tubulars include, but are not limited to, Xponent, RS-8HT, RS-8PI, RS 9, RS 51, RS 52, PMR-II-50, AFR700B, DMBZ-15, and HFPE-II-52, available from YLA, Inc. of Benicia, Calif., USA, RS 3, EX 1505, and EX 1551, available from TenCate of Almelo, the Netherlands, AVIMID K3B, AVIMID N, AVIMID R, AVIMID RB, CYCOM 944, CYCOM 2237, CYCOM 3002, CYCOM 3010, CYCOM 5004, CYCOM 5245C, CYCOM 5250-4, CYCOM 5270, and CYCOM 5575, available from Cytec Industries Inc. of West Paterson, N.J., USA, F650, F652, F655, and M65, available from Hexcel Corporation of Stamford, Conn., USA, RP-46, available from Unitech Corporation of Hampton, Va., USA, SuperImide, available from Goodrich Corporation of Arlington, Va., USA, and PETI 330 and PETI 365, available from UBE Industries Limited of Tokyo, Japan. The coating material applied to the well tubular depends on the underlying composite material, but often the coating material is a curable material selected to fully bond with the underlying matrix, as described in greater detail below.

The fiber reinforced composite material may also be formed with other additives to affect the properties of a given well component. For example, fillers may be added to alter the flexural strength of the composite material or to affect other properties, e.g. electrical conductivity, of the composite material. Often the amount of filler material added is less than five percent by weight. Examples of fillers include kaolinite, illite, montmorillonite, mica, and silica (in the form of spheres or plates), all of which can be pretreated with, for example, maleimido functionalized silane, aminopropyl silane, sulfide, or fluorinated silane.

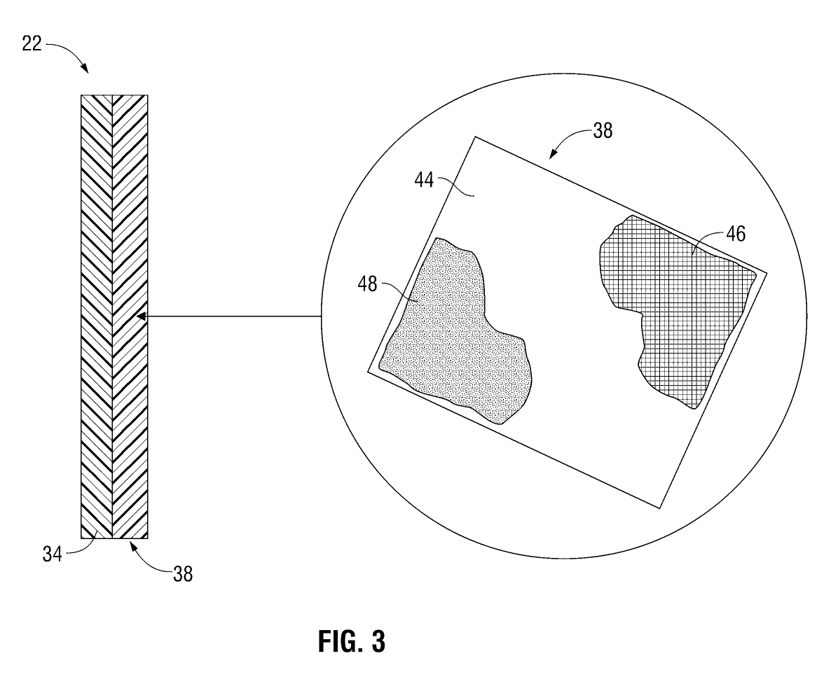

Referring generally to FIG. 3, one example of coating 38 is illustrated. In this embodiment, coating 38 is covalently bonded with base structure 34 of well component 22 to prevent the ingress of water and other deleterious fluids while well component 22 is utilized in a downhole environment. The coating 38 comprises layers or segments of material in the form of modulated layers. For example, this embodiment of coating 38 comprises a resin rich layer 44 selected such that curing of the base structure 34 and coating 38 creates covalent binding between the coating 38 and base structure 34. By way of example, the fiber reinforced composite material forming base structure 34 may comprise a bismaleimide resin, and resin rich layer 44 may comprise a maleimide complex able to form covalent bonds with the base structure material. The illustrated coating 38 further comprises a reinforcement layer 46 which may be in the form of a veil or cloth material. Additionally, coating 38 comprises a filler material 48 that may be arranged in a filler rich layer to affect the characteristics of coating 38.

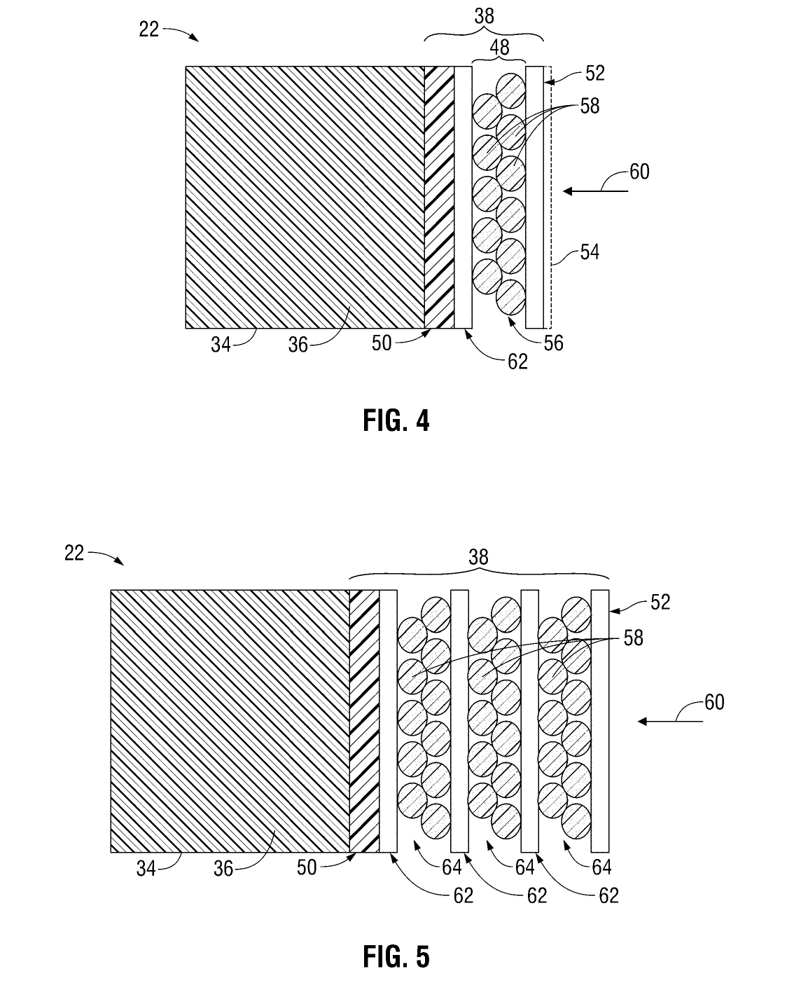

In FIG. 4, another embodiment of coating 38 is illustrated as applied to and bonded with the fiber reinforced composite material 36 of base structure 34. In this example, the fiber reinforced composite material 36 comprises a fiber reinforced resin, and coating 38 comprises a multilayer coating to protect the fiber reinforced composite material 36 from contact with deleterious well fluid. The structure of coating 38 is designed to provide an impermeable coating so the well component 22, e.g. tubular component 32, can continue to function in the downhole environment without experiencing degradation.

In the embodiment illustrated, coating 38 comprises a modulated resin layer 50 adjacent the base structure 34. The modulated resin layer 50 is designed to bond with the base structure material while providing a smooth transition of properties between the coating 38 and the resin matrix of fiber reinforced composite material 36. This ensures improved barrier coating, thermal transition, chemical bonding, and overall mechanical stability of the well component 22. The coating 38 further comprises an impermeable, compliant layer 52 positioned for exposure to the surrounding well fluid. The impermeable, compliant layer 52 may be formed from a dense material, such as flexible glass in sheet form, mica in sheet form, silicon oxide applied by vapor deposition, or silicon carbide applied by vapor deposition. In some cases the mica sheet may be corrugated. Additionally, a sacrificial layer 54 (shown in dashed lines) may be disposed along an exterior of the impermeable, compliant layer 52.

The coating 38 further comprises an internal layer 56 having embedded reactive chemistries selected to protect the fiber reinforced composite material 36 against ingress of undesirable fluids in a downhole environment. The internal layer 56 may be disposed between modulated resin layer 50 and impermeable, compliant layer 52 and further comprise filler material 48 in the form of a reagent 58 that is reactive to permeating/invading fluid, represented by arrow 60. The reagent 58 may be in a solid form, e.g. powder or particles, that react if contacted by a specific deleterious, downhole fluid. Furthermore, coating 38 may comprise an impermeable film and/or selective membrane 62 disposed between modulated resin layer 50 and internal layer 56.

The combined layers or segments of coating 38 present a coating that is compliant to external (radial) fluid pressure and/or formation stress expected in downhole, subterranean environments. However, even if such loading eventually causes cracks or ruptures in the impermeable, compliant layer 52, the subsequent exposure of reagent 58 to the permeating fluid 60 results in an automatic reaction of reagent 58 to effectively repair/regenerate coating 38. The reaction of reagent 58 ensures the continued impermeability of coating 38 with respect to deleterious well fluids 60. Accordingly, reagent 58 serves to provide a reactive in-situ coating as needed.

Another embodiment of coating 38 is illustrated in FIG. 5. In this embodiment, coating 38 again comprises modulated resin layer 50 and impermeable, compliant layer 52. However, internal layer 56 comprises a plurality of reagent layers 64 separated by film/membranes 62 as illustrated. Each of the reagent layers 64 comprises a unique reactive reagent designed to react in the presence of specific types of potentially invading materials in a manner that blocks ingress of those deleterious materials. By way of example, the coating 38 may comprise three reagent layers 64 with each layer having a unique reactive reagent. In one example, the reactive reagents comprise a hydrogen sulfide reactive reagent, a water reactive reagent, and a carbon dioxide reactive reagent, respectively. However, coating 38 may comprise additional or fewer reagent layers 64 with a variety of reactive reagents as desired for a given downhole environment and application.

The design of coating 38 in the embodiment of FIG. 5 enables the sequential and selective blocking of various permeating fluid molecules to prevent those molecules from reaching the fiber reinforced composite material 36. This type of coating can be adjusted for a variety of wet, harsh, downhole environments so as to preserve the mechanical integrity of the underlying base structure 34. The film/membrane 62 also may be modulated to provide a smooth horizontal transition through the coating 38 to the base structure 34.

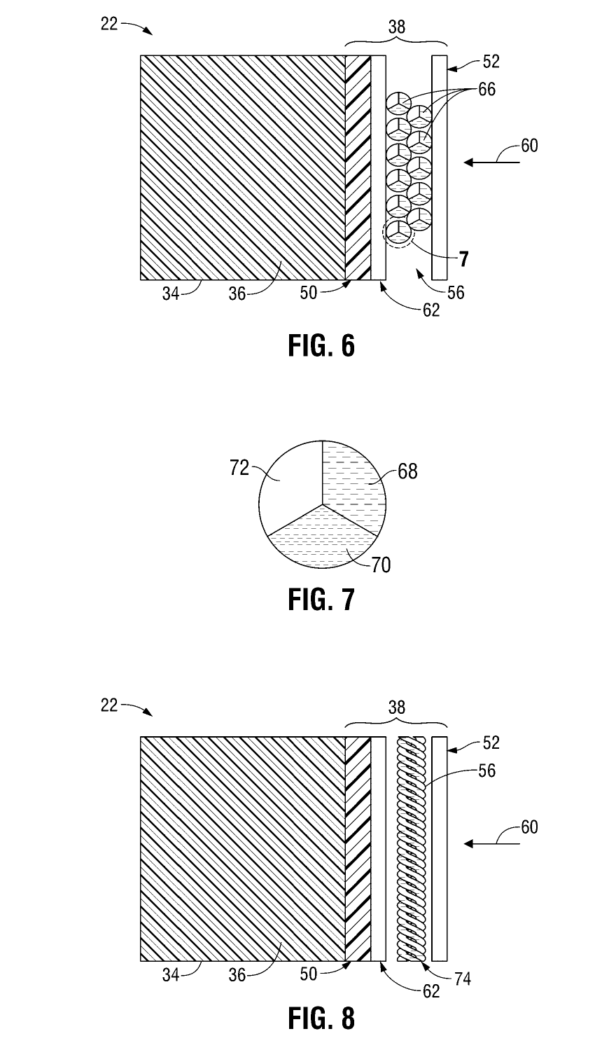

Another embodiment of coating 38 is illustrated in FIG. 6. In this embodiment, coating 38 again comprises modulated resin layer 50, impermeable, compliant layer 52, and film/membrane 62. However, internal layer 56 comprises particles 66 that are designed as multi-reagent particles. The particles 66 can be packed between modulated resin layer 50 and impermeable, compliant layer 52 in a homogeneous distribution. The distribution of particles 66 enables selective and simultaneous reactions with a multi-component permeating fluid mixture. Furthermore, the film/membrane 62 may be either homogeneously or discreetly layered (modulated) to provide an effective impermeable film.

One example of a multi-reagent particle 66 is illustrated in FIG. 7 as providing three reagents 68, 70, 72 combined in each particle 66. By way of example, the reactive reagents may be selected to react with hydrogen sulfide, water, and carbon dioxide, respectively. However, different types and numbers of reactive reagents can be combined in each particle and used in internal layer 56 created by densely packed particles 66.

A similar embodiment of coating 38 is illustrated in FIG. 8. However, the tri-reagent particles illustrated in FIG. 6 have been replaced by a fiber structure 74 to form inner, e.g. embedded, layer 56. The fiber structure 74 may comprise a braided fiber structure having a plurality of fiber shaped reactive reagents that are intertwined between modulated resin layer 50 and impermeable, compliant layer 52 in a homogeneous distribution. The distribution of reactive reagent fibers in fiber structure 74 enables selective and simultaneous reactions with a multi-component permeating fluid mixture. Again, the film/membrane 62 may be either homogeneously or discreetly layered (modulated) to provide an effective impermeable film. By way of example, the reactive reagent fibers may be selected to react with hydrogen sulfide, water, and carbon dioxide, respectively. However, different types and numbers of reactive reagents can be combined in the fiber structure 74 to create layer 56. Additionally, alternate layers or different numbers of layers can be used in various embodiments of coating 38.

As described above, a variety of resins and materials can be used to create both the fiber reinforced composite material 36 and the coating 38. In one example, however, the fiber reinforced composite comprises a fiber reinforced polymer material created with bismaleimide, a high temperature thermoset resin. In this embodiment, coating 38 comprises a maleimide complex that can also be referred to as an imide-extended bismaleimide. The maleimide complex provides a hydrophobic coating that is able to form covalent bonding with the adjacent fiber reinforced polymer structure which is formed with bismaleimide high temperature thermoset resin. The bonding between this type of substrate and the maleimide complex coating 38 may be facilitated by the terminal maleimide reactive groups present in the maleimide complex. The presence of these reactive functional groups enables the formation of covalent bonds between the hydrophobic coating 38 and the bismaleimide substrate that is continuous and resistant to delamination.

Maleimides can be cured thermally or in the presence of free-radical initiators to yield polysuccinimides. The maleimides may also be reacted with amines, thiols, or malonates via the Michael addition reaction. Maleimides can also react with unsaturated compounds to form covalent bonds via the Ene reaction. The source of unsaturation for the Ene reaction can come through the addition of discrete additives, such as polybutadiene, or from the backbone of the maleimide compound itself. The maleimide functional group is a powerful dieneophile which can also form covalent bonds according to the Diels-Alder reaction. Additionally, maleimides can form perfectly alternating co-polymers with electron-rich vinyl compounds, such as a-olefins and vinyl ethers. Furthermore, the aliphatic maleimide residues present in the maleimide complex can polymerize in the presence of ultraviolet radiation without the requirement of any added photo initiator.

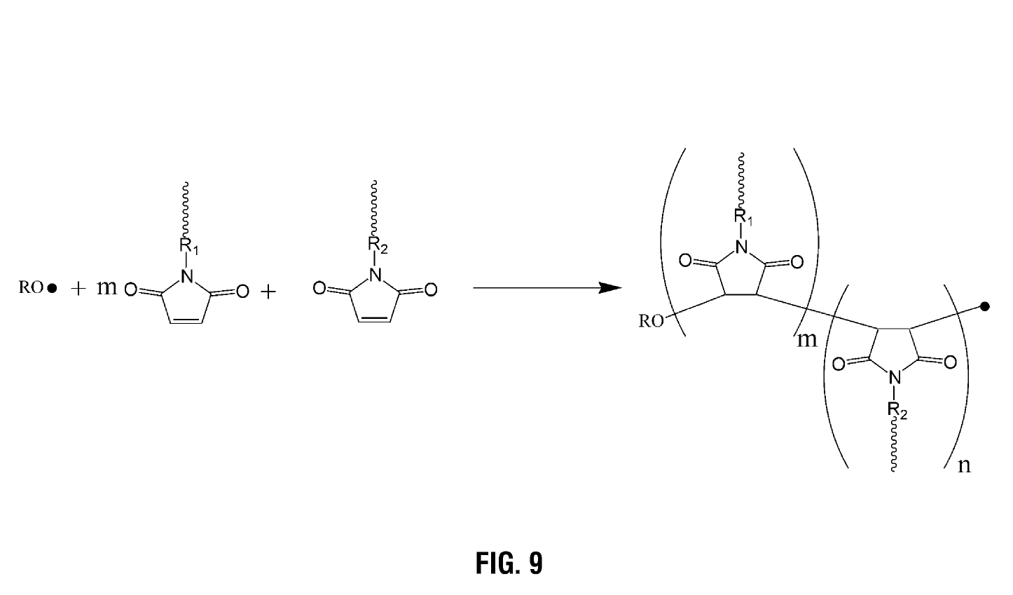

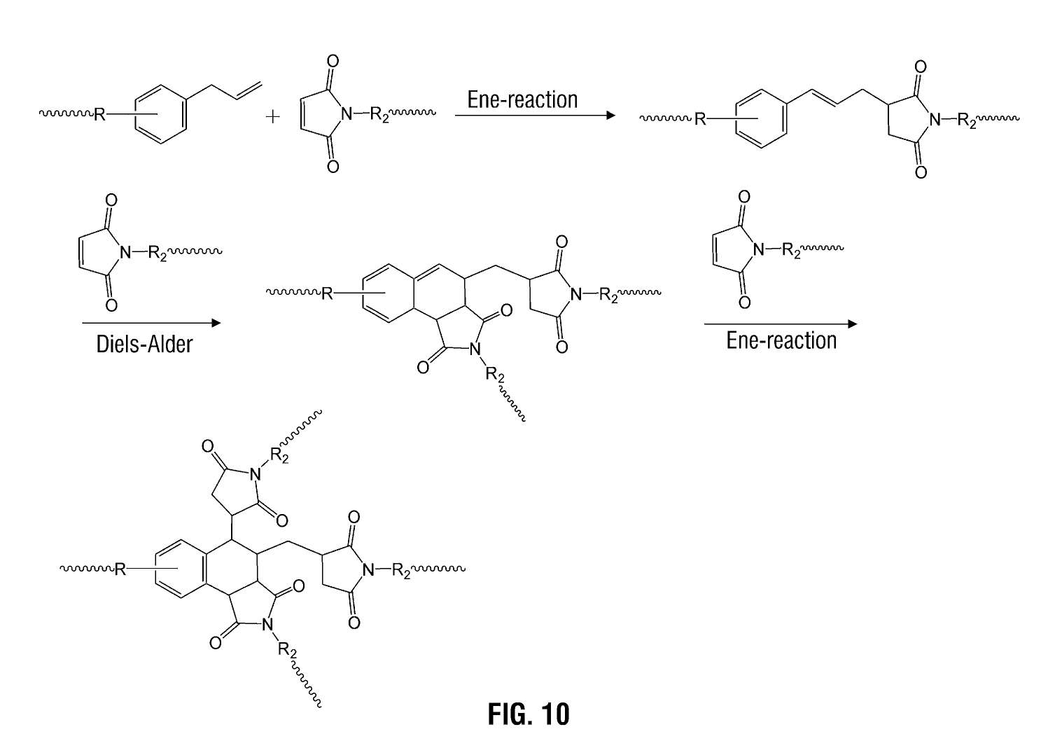

The presence of terminal maleimide groups in the filled or unfilled maleimide complex can directly co-cure with any residual maleimide functionality or associated curatives present in the bismaleimide composite material 36. The mechanism for this direct bonding may be mediated via the free radical co-cure of the residual maleimide functionality in the bismaleimide composite material 36 and the terminal maleimide groups in the maleimide complex. Direct co-cure of maleimide residues at the composite material 36/coating 38 interface can result in the formation of polysuccinimide chain segments as illustrated in FIG. 9. Additionally, the bismaleimide composite resin can cure in the presence of allyl compounds. A representation of the reaction of an allyl curative and maleimide functional resin is illustrated in FIG. 10. Furthermore, it is possible for residual allyl, or partially reacted allyl residues, to be present at the surface of the bismaleimide composite material 36 to serve as additional covalent binding sites for the maleimide complex coating 38.

For high temperature applications, bismaleimide resin is a very suitable thermoset resin that can be used to construct fiber reinforced composite material 36. Additionally, forming coating 38 with maleimide complex provides a coating that is electrically non-conductive and transparent, e.g. nuclear magnetic resonance transparent, with respect to various logging tools that can be used downhole. As described above, the coating 38 may be augmented with inorganic and/or reactive fillers to reduce or eliminate ingress of deleterious downhole fluids, such as water. By way of specific example, the maleimide complex ensures good bonding with the bismaleimide base material 36, while the reactive reagents and/or additional layers can protect the composite material 36 against the ingress of unwanted fluids. When the well tubular is to be used as casing for certain logging operations, the casing in designed to have at least a minimum conductivity to enable effective transfer of logging signals into the formation. Use of carbon fillers and carbon fibers may be considered in such applications. Similarly, coatings containing carbon can be used for tools/components which are not required to be electromagnetically transparent. The surface of the carbon can be derivatized to improve its bonding to the polymer resin or for some other functionality.

Coatings 38 may be prepared and cured according to various techniques that depend on the materials used to construct the coating and on the environment in which the coating is to be used. In one embodiment, a flexible, high temperature, hydrophobic coating is prepared by melting maleimide complex resins, such as those synthesized by Designer Molecules Inc. of San Diego, Calif., USA. The maleimide complex resins are melted at a high-temperature, e.g. above 100° C., and degassed under full vacuum until foaming subsides. The degassed melt is then cooled, e.g. to less than 90° C., and mixed with a sufficient amount of curing agent, e.g. 1-2 weight percent dicumyl peroxide, before being poured into a mold. Alternatively, a veil and/or filler can be included at this stage. The film/coating is then cured. By way of example, the coating may be cured at 125° C. for 14 hours followed by several days at 140° C., although other curing schedules can be utilized.

In this example, the molecular weight distribution and the curing technique is selected so the maleimide complex does not lose weight when immersed in deionized water at, for example, 80° C. Liquid water is used rather than water vapor to be consistent with an oilfield environment. The temperature, e.g. 80° C., is selected according to the phase transition point for the cured material. It should be noted that the maleimide complex-based coating may be stable up to temperatures of 300° C. and above in various environments. This is substantially higher than low temperature amine-based epoxy coatings. Additionally, the maleimide complex-based coating absorbs a substantially lower amount of water (less than 1 weight percent) at, for example, 80° C.

Although various resins can be used in formulating coating 38, the maleimide complex-based coating provides a substantial barrier not only to water but also to other fluids, such as carbon dioxide, and other deleterious chemicals. The barrier properties of the coating 38 may be enhanced for certain applications by adding fillers, such as reagent 58. For example, particles or sheets of inorganic materials may be added to the maleimide films to further reduce layer permeability. Samples of such fillers include calcium oxide, either dispersed through the maleimide complex layer or compacted between sheets pre-impregnated with maleimide complex.

Alternatively, a sheet of inorganic material may be included in the sheets pre-impregnated with maleimide complex. By way of example, the inorganic sheet comprises corrugated mica. The surface of the mica sheet may be partially or completely derivatized with reactive functional groups, such as silanes, or simple mixtures, such as mixtures with silicone oil. In another variation, the inorganic layer may comprise a thin flexible glass such as those commercially available from Schott North America, Inc. —Advanced Materials of Elmsford, N.Y., USA. In another variation the maleimide coating can, after curing, be saturated or conditioned with oil or any hydrophobic fluid, or a reactive silane or silicate with the intention of reducing the permeability by blocking any pores remaining after curing.

In another example, the reagent 58 comprises an ion exchange resin, such as Amberlyst 70 available from Rohm and Haas Corporation of Philadelphia, Pa., USA, a subsidiary of The Dow Chemical Company, which can remove the effect of pH on the resin. The reagent can also be combined with space, e.g. void and/or free volume, and fillers which may be in the form of silica, silica treated with maleimide functionalized silane, glass flakes, kaolinite, montmorillonite, mica, or organic materials, e.g. polyethylene or polyphenylene sulfide. Alternatively, the filler material may comprise a silane based gel with vinyl, amino, or maleimido functionality. Such primers can be synthesized by a maleimido propyltrimethoxy silane method. Another filler material that can be used in some applications comprises aluminium nitride. Such a filler is useful in applications where water influx into a polymer is associated with low pH (carbon dioxide, hydrogen sulfide), and the ammonia released by the aluminium nitride on contact with water can help control the pH. The ammonia can also be beneficial to certain polymers, such as bismaleimide. Other water-removing materials include silica gel, a mixture of sodium silicate and an aluminosilicate (e.g. metakaolin) that forms a so-called geopolymer on contact with water or a molecular sieve.

The coatings 38 may be manufactured according to a variety of processes. By way of one example, molten maleimide complex resin is poured over high temperature reinforcing support material, e.g. cloth, and sandwiched between two high temperature non-stick sheets. An example of such reinforcing support material is Nexus veil sheets, available from Precision Fabrics Group, Inc. of Greensboro, N.C., USA. The sandwiched material is then placed under optimal weight/pressure inside a curing oven at, for example, 125° C. The curing oven is programmed to subject the coating to a desired curing schedule for a given application. This type of curing process provides coatings that are generally flexible and flawless.

The coating material is fully or partially cured so that it has sufficient mechanical strength for application to a base structure 34 formed from fiber reinforced composite material 36, such as a bismaleimide-based material. Depending on the specific application, the coating material may be glued onto a pre-cured base structure 34 or placed in contact with a curing base structure 34. The cure may then be completed with the coating 38 applied to the fiber reinforced composite material 36 of base structure 34.

Coating 38 is designed to form a secure, covalent bond with the fiber reinforced composite material 36 of a given base structure 34, such as a casing or other tubular component. Depending on the specific well environment, coating 38 may comprise a variety of fillers, layers, and other materials designed to react with or otherwise block the influx of deleterious well fluids. In some applications, the coating 38 can be applied to the interior and/or exterior of a tubular base structure 34 to protect the base structure 34 from internal and/or external fluids.

Furthermore, coating 38 may be formed with a variety of layers and from a variety of materials. The resin materials used to create coating 38 may be selected according to the corresponding fiber reinforced composite material 36 used to construct the underlying substrate. Additionally, the reactive reagents may vary in type, form, and amount depending on the environment into which the coated well tubular is to be delivered. Furthermore, the curing procedures and manufacturing processes can vary according to the materials used and the components coated. Curing procedures and manufacturing processes are also adjustable based on numerous other environmental and manufacturing considerations. Regardless, coating 38 is able to provide long-lasting protection against the ingress of unwanted fluids in a high temperature, wellbore environment.

Accordingly, although only a few embodiments of the present invention have been described in detail above, those of ordinary skill in the art will readily appreciate that many modifications are possible without materially departing from the teachings of this invention. Such modifications are intended to be included within the scope of this invention as defined in the claims.

What is claimed is:

1. A well tubular, comprising:
a polymer base structure; and
a coating chemically bonded to the polymer base structure.

2. The well tubular as recited in claim 1, wherein the coating is modulated.

3. The well tubular as recited in claim 1, wherein the coating comprises a resin.

4. The well tubular as recited in claim 1, wherein the coating comprises a sheet of flexible glass.

5. The well tubular as recited in claim 1, wherein the coating comprises a sheet of mica.

6. The well tubular as recited in claim 5, wherein the sheet of mica is corrugated.

7. The well tubular as recited in claim 1, wherein the coating comprises silicon oxide.

8. The well tubular as recited in claim 7, wherein the silicon oxide is applied by vapor deposition.

9. The well tubular as recited in claim 1, wherein the coating comprises silicon carbide.

10. The well tubular as recited in claim 9, wherein the silicon carbide is applied by vapor deposition.

11. The well tubular as recited in claim 1, wherein the coating comprises a layer having an embedded reactive chemistry selected to protect the polymer base structure in a downhole environment.

12. The well tubular as recited in claim 11, wherein the layer having an embedded reactive chemistry is disposed between an inner modulated resin layer and an outer impermeable, compliant layer.

13. The well tubular as recited in claim 12, wherein the embedded reactive chemistry comprises a reagent that is reactive to a potentially permeating well fluid.

14. The well tubular as recited in claim 12, wherein the embedded reactive chemistry comprises a plurality of reagent layers, each reagent layer having a specific reactive reagent.

15. The well tubular as recited in claim 12, wherein the embedded reactive chemistry comprises particles creating a mixture of reactive reagents that are reactive to specific substances potentially located in a downhole environment.

16. The well tubular as recited in claim 12, wherein the embedded reactive chemistry comprises a braided structure of reactive reagents that are reactive to specific substances potentially located in a downhole environment.

17. The well tubular as recited in claim 1, wherein the polymer base structure is formed with a bismaleimide resin.

18. The well tubular as recited in claim 17, wherein the coating comprises a maleimide complex.

19. The well tubular as recited in claim 18, wherein the coating further comprises a reinforcement material.

20. The well tubular as recited in claim 18, wherein the coating further comprises a veil.

21. The well tubular as recited in claim 1, wherein the coating forms a covalent bond with the polymer base structure.

22. The well tubular as recited in claim 1, wherein the polymer base structure is fiber reinforced.

23. The well tubular as recited in claim 22, wherein the fibers are carbon fibers.

24. The well tubular as recited in claim 1, wherein the coating comprises an inner modulated resin layer.

25. The well tubular as recited in claim 24, wherein the coating comprises an outer impermeable, compliant layer.

26. A method of constructing a well tubular, comprising:
constructing a base structure of the well tubular from a polymer material;
preparing a coating; and
creating chemical bonding between the coating and the base structure.

27. The method as recited in claim 26, wherein the coating is hydrophobic.

28. The method as recited in claim 27, wherein the hydrophobic coating is prepared in a plurality of layers.

29. The method as recited in claim 28, wherein at least one of the plurality of layers comprises a reactive reagent selected to react in the presence of a deleterious well fluid.

30. The method as recited in claim 26, wherein the bonding between the coating and base structure is covalent.

31. The method as recited in claim 26, wherein the base structure is constructed with bismaleimide resin.

32. The method as recited in claim 31, wherein the base structure is fiber reinforced.

33. The method as recited in claim 31, wherein the coating is prepared with a maleimide complex.

34. The method as recited in claim 33, wherein the coating is prepared with a filler material.

35. The method as recited in claim 34, wherein the filler material contains a material selected from the group consisting of calcium oxide, carbon, silica, silica gel, glass flakes, kaolinite, montmorillonite, mica, organic material, aluminum nitride, metakaolin, and a silane based gel with vinyl, amino, or maleimido functionality.

36. A coating for use on a downhole component formed of a polymer material, the coating comprising:
a plurality of layers in which at least one layer is formed of a material having a reactive chemistry selected to react in the presence of downhole well fluids that are deleterious to the polymer material; and
a layer able to undergo covalent bonding with the polymer material.

37. The coating as recited in claim 36, wherein the at least one layer comprises a reactive reagent, the at least one layer being located between a modulated resin layer and an impermeable, compliant layer.

38. The coating as recited in claim 36, wherein the coating comprises a maleimide material.

39. A method of constructing a protected well tubular, comprising:
constructing a base structure from a polymer material;
forming a coating with an embedded reactive chemistry to protect the polymer material from deleterious fluid found in a downhole environment;
applying the coating to the base structure; and
curing the coating to form a bond with the base structure.

40. The method as recited in claim 39, wherein forming the coating comprises forming the coating from materials transparent with respect to downhole logging operations.
